(19) United States
(12) Patent Application Publication
(10) Pub. No.: US 2004/0196670 A1
(43) Pub. Date: Oct. 7, 2004

(54) Digital time mirrored pulse width modulate controller

(76) Inventors: Chin-Tsai Hong, Taipei (TW); Chung-Fu Chou, Taipei (TW); Chun-Ting Lu, Chuang City (TW); Thou-Vun Pang, Chung-Ho City (TW)

Correspondence Address: SUPREME PATENT SERVICES, POST OFFICE BOX 2339, SARATOGA, CA, 95070, US

(21) Appl. No.: 10/407,997

(22) Filed: Apr. 3, 2003

(51) Int. Cl. H02M 3/335

(52) U.S. Cl. 363/19

(57) ABSTRACT

This invention relates to a digital time mirrored pulse width modulate controller. The controller is electrically connected to a converter unit in which it comprises at least one comparator unit. The comparator unit outputs/inputs a voltage (Vo) and a preset voltage (Vset), and outputs a phase signal having low-level and high-level standards and a core digital processing unit, wherein the core digital processing unit outputs a pulse width modulate signal, through the units mentioned above. The characteristics of the invention can be summed up as follows: the elapsed time of the phase signal in high-level and in low-level is equal, and the root mean square of the output voltage in converter unit is equal to the preset voltage (Vset).

### FIELD OF THE INVENTION

This invention relates to a digital time mirrored pulse width modulate controller, the controller is electrically connected to a converter unit in which it comprises: at least one comparator unit, the comparator unit output/input a voltage (Vo) and a preset voltage (Vset), and output a phase signal having low-level and high-level standards and further a core digital processing unit is also included, wherein the core digital processing unit output a pulse width modulate signal, through the units mentioned above, the characteristics of the invention can be summed up as follows: the elapsed time of the phase signal in high-level and the elapsed time in low-level are equal, and the root mean square of the output voltage in converter unit is equal to the preset voltage (Vset).

### BACKGROUND OF THE INVENTION

U.S. Pat. No. 6,456,510, entitled “Unique method of reducing losses in circuits using V2 PWM control”, discloses a modulate power supply, wherein a switching rectifier square wave output is adopted in a wave filter device. The wave filter device comprises inductance in series and capacitor in parallel. The wave filter device is lack of resistance in series. The ramp signal is generated when connecting to a second capacitor. The second capacitor and the first resistance are connected in series and further connected with a switching rectifier in parallel. An amplifier adds the ramp signal to a power supply and generates an output error signal. The generated output is then input to a control electric circuit. The control electric circuit will generate a voltage control signal to guide the rectifier for switching.

U.S. Pat. No. 6,456,510, entitled “Unique method of reducing losses in circuits using V2 PWM control”, discloses to a DC/DC converter (1;20), wherein the device comprises electrical inductance energy storage tool (L), exchange tool (S1-S4) and control tool (6;15), wherein the control tools are devices for selectively operating the exchange tool (S1-S4) and to provide a transferring of a certain electrical energy from the energy storage tool (L) to the output of DC/DC converters (1;20) and it also provides an associated output voltage (Vout). The characteristic of the invention is mainly focused on through the digital control tool (6;15), wherein the control tool are modulates for operationally control the exchange tools (S1-S4) for physically recharging and discharging the electric energy under the circumstance of up exchange and down exchange ramp signal periodically.

### SUMMARY OF THE INVENTION

The first purpose of this invention is based on the fact that through the time domain phase signal mirrored way to obtain a characteristic such that the elapsed time of high level standard is equal to the elapsed time of low level standard.

The second purpose of the present invention is based on the fact that through the time domain phase signal mirrored way to obtain a characteristic such that the root mean square of the output voltage of the converter unit is equal to a preset voltage.

The third purpose of the present invention is based on the fact that the voltage level standard of the preset voltage lies in the range between peak and trough of the output voltage (but not include) in order to avoid the output voltage glitch wave from occurring.

The present invention will become more obvious from the following description when taken in connection with the accompanying drawings which show, for purpose of illustration only, a preferred embodiment in accordance with the present invention.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 depicts a block diagram showing the function of each unit in first embodiment;

FIG. 2 depicts a block diagram showing the associated signal time series of each unit in first embodiment;

FIG. 3 depicts a block diagram showing the time series of the associated signal and prior art control device in the second embodiment;

FIG. 4 depicts a diagram showing the detailed circuit connection of the time mirrored pulse width modulate controller in first embodiment of the present invention;

FIG. 5 depicts a diagram showing the detailed circuit connection of the time mirrored pulse width modulate controller in third embodiment of the present invention; and

FIG. 6 depicts a diagram showing the state transition diagram of the time mirrored pulse width modulate controller of the present invention.

### DETAILED DESCRIPTION OF THE PREFERRED EMBODIMENT

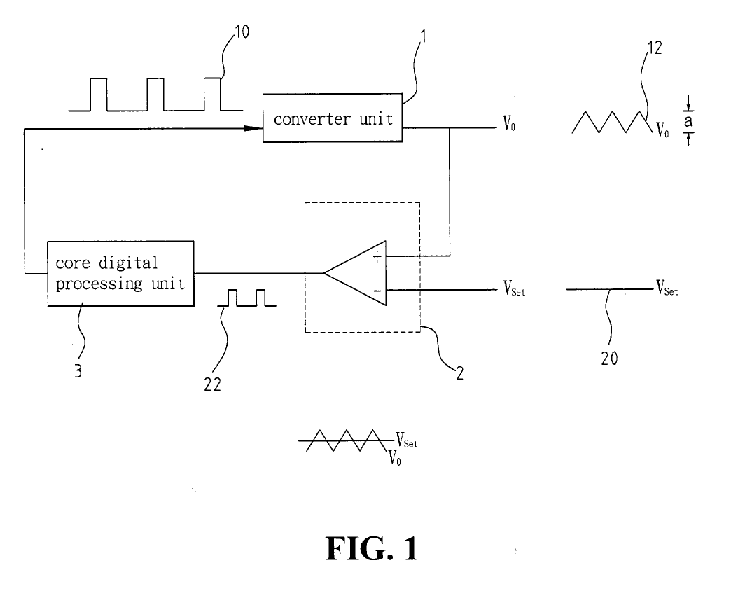

FIG. 1 is the block diagrams showing each function unit in the first embodiment. The present invention naming the digital time mirrored pulse width modulate controller using the phase signal time domain mirrored way to obtain a characteristic such that the elapsed time of high level standard and the elapsed time of low level standard is equal, and such that the root mean square of the converter unit output voltage is equal to a preset voltage (Vset).

The digital time mirrored pulse width modulate control is electrically connected to a converter unit 1. The converter unit 1 comprises at least one input terminal and at least one output terminal. The input terminal is an input channel for a pulse width modulate signal 10 and through the control of the input pulse width modulates signal 10, the output terminal generates an output voltage (Vo) 12 to serve for the usage of one load, comprising at least one comparator unit 2. The comparator unit 2 has a positive input terminal, a negative input terminal and an output terminal. The positive input terminal and the negative input terminal have an output voltage (Vo) from the converter unit 1 and a set voltage (Vset) 20. The output terminal provides a phase signal 22 as an output. The phase signal 22 has high level standard and low level standard, and a core digital processing unit 3, wherein the core digital processing unit 3 comprises at least one input terminal and at least one output terminal, wherein the input terminal receive phase signal 22 as an input, and output a pulse width modulate signal 10 as an output.

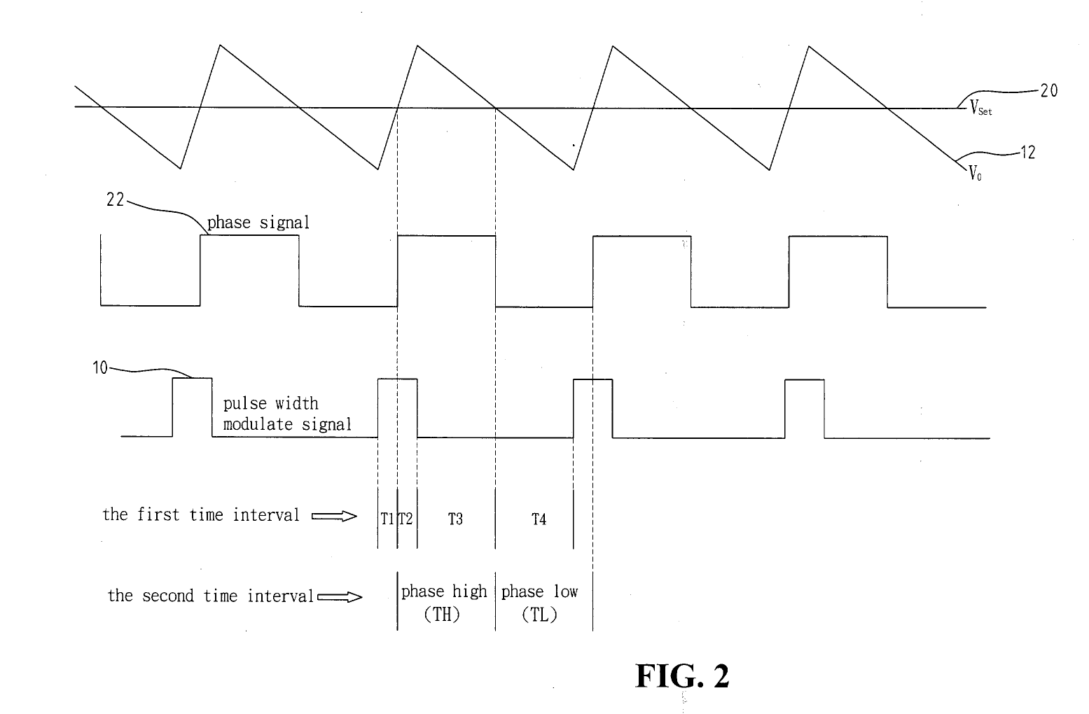

FIG. 2 is the respective unit function signal time series of the first embodiment. The digital time mirrored pulse width modulate controller device comprises the converter unit 1, wherein the output terminal of the converter unit 1 generates an output voltage (Vo) 12 to serve for the use of at least one load. The output voltage (Vo) 12 has a ripple characteristic such that the difference of the peak and the trough of the ripple is about several micro-volt (mV) and denoted here as a.

In comparator unit 2, a set voltage (Vset) 20 is input to a negative input terminal, while the output voltage (Vo) 12 of the converter unit is input to a positive input terminal, thus generating a phase signal 22 in the output terminal of the comparator unit 2. The phase signal 22 has two kinds of level standards, which includes the high level standard and low level standard. It is to be noticed that the level standard of the set voltage (Vset) 20 lies between (but not include) the peak and trough of voltage level standard.

The core digital processing unit 3 input terminal receives phase signal 22 as an input and output a pulse width modulate signal 10 to an output terminal. Pulse width modulate signal 10 has a high-side level standard and a low-side level standard. The high-side level standard pulse width modulate signal 10 is able to drive load in converter unit 1, while the low-side level standard pulse width modulate signal 10 is unable to drive load in converter unit 1.

According to the first embodiment, digital time mirrored pulse width modulate controller, the pulse width modulate signal 10 in a time period contains the first time interval T1, the second time interval T2, the third time interval T3, the fourth time interval T4, satisfy the condition one's requirement: the elapsed time of the first time interval T1 and the elapsed time of second time interval T2 is equal, the elapsed time of first time interval T3 and the elapsed time of the fourth time interval T4 is equal. In other words, the sum of the elapsed time of the first time interval T1 and the fourth time interval T4 is equal to the sum of the elapsed time of the second time interval T2 and the third time interval T3, which is just in match with the elapsed time of phase signal between the phase high (TL) and the phase low (TL), this is the condition two requirement.

The pulse width modulate signal 10 in the initial stage is started by default internal preset voltage and jump from low-side level standard to high-side level standard. The starting point of the first time interval is the time when pulse width modulate signal 10 is jumping from low-side level standard to high-side level standard. The ending point of the first time interval T1 is the time when the phase signal changing from low-side standard to high-side standard, in the mean while, the pulse width modulate signal 10 in the first time interval remain on the high-side standard.

The starting point of the second time interval is the ending point of pulse width modulate signal 10 in the first time interval, the ending point of the second time interval is calculated from the starting point of the second time interval until the elapsed time of the first time interval, and the pulse width modulate signal 10 in the second time interval is still remain on the high-side level standard, while the ending the second time interval is dropping from high-side level standard to low-side level standard.

The starting point of the third time interval is the ending point of the second time interval of the pulse width modulate signal 10, the ending point of the third time interval is the phase signal 22 changing from high level standard to low level standard, and the pulse width modulate signal 10 in the third time interval remain the low-side level standard.

The starting point of the fourth time interval is the ending point of the third time interval of the pulse width modulate signal 10, the ending point of the fourth time interval is calculated from the starting point of the fourth time interval the elapsed time interval in third time interval, in principle, the point is also the starting point of the next cycle, and the pulse width modulate signal 10 in the fourth time interval still remain on the low-side level standard, the ending point of the fourth time interval is jumping from low-side level standard to high-side level standard.

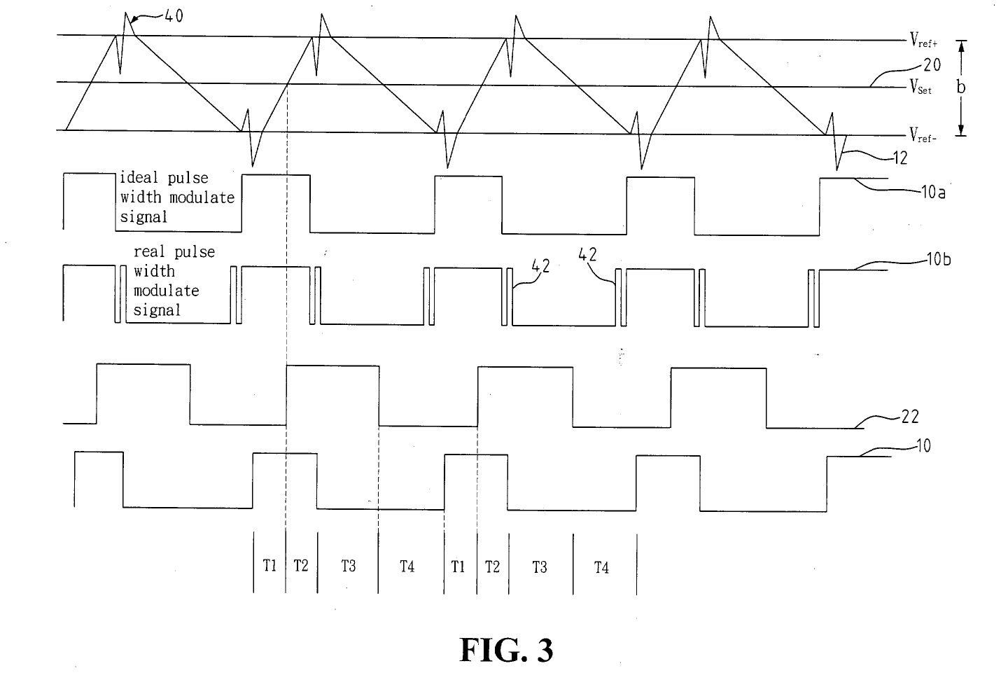

FIG. 3 is the respective unit function signal and prior art controller time series of the second embodiment of the present invention, the digital time mirrored pulse width modulate controller device comprises converter unit 1, the converter unit 1 output terminal generates an output voltage (Vo) 12 to serve for the use of at least one load. The output voltage (Vo) 12 has a ripple characteristic such that the difference of the peak and the trough of the ripple is about several micro volt (mV) and denoted here as b.

From the previous prior art, the controller outputs an output voltage (Vo) 12 separately when running across the positive reference voltage (Vref+) and the negative reference voltage (Vref−), it will feed back a pulse width modulate signal 10 when jumping from low-side level standard to high-side level standard or when dropping from high-side level standard to low-side level standard, theoretically, it will generate an ideal pulse width modulate signal 10a as shown in FIG. 3. But actually, when the circuit is turn on/off, an output voltage (Vo) 12 will generate a series of glitch wave 40 (such as circle wave) such that the real pulse width modulate signal 10b will generate glitch 42. The important characteristic of the second embodiment of the present invention just lies in the scope: a set voltage 20 level standard lies between the output voltage peak and trough (but not included) of the converter unit 1, so this can avoid the occurrence of glitch 40 (as indicated as circle).

In FIG. 3, according to the second embodiment of the present invention, the digital time mirrored pulse width modulate control device signal 10 in a time period contains the first time interval T1, the second time interval T2, the third time interval T3, the fourth time interval T4, satisfy the condition one's requirement: the elapsed time of the first time interval T1 and the elapsed time of second time interval T2 is equal, the elapsed time of third time interval T3 and the elapsed time of the fourth time interval T4 is equal. In another word, the sum of the elapsed time of the first time interval T1 and the fourth time interval T4 is equal to the sum of the elapsed time of the second time interval T2 and the third time interval T3, which is just in match with the elapsed time phase signal between the phase high (TH) and the phase low (TL), this is condition two requirement.

The pulse width modulate signal 10 in the initial stage is started by default pre-set voltage and jump from low-side level standard to high-side level standard. The starting point of the first time interval is the time when pulse width modulate signal 10 is jumping from low-side level standard to high-side level standard. The ending point of the first time interval T1 is the time when the phase signal 22 changing from low-side level standard to high-side level standard, in the mean while, the pulse width modulate signal 10 in the first time interval remain on the high-side level standard.

The starting point of the second time interval is the ending point of pulse width modulate signal 10 in the first time interval, the ending point of the second time interval is calculated from the starting point of the second time interval until the elapsed time of the first time interval, and the pulse width modulate signal 10 in the second time interval is still remain on high-side level standard, while the ending point of the second time interval is dropping from high-side level standard to low-side level standard.

The starting point of the third time interval is the ending point of the second time interval of the pulse width modulate signal 10, the ending point of the third time interval is the phase signal 22 changing from high level standard to low level standard, and the pulse width modulate signal 10 in the third time interval remain on the low-side level standard.

The starting point of the fourth time interval is the ending point of the third time interval of pulse width modulate signal 10, the ending point of the fourth time interval is calculated from the starting point of the fourth time interval through the elapsed time interval in third time interval, in principle, the point is also the starting point of the next cycle, and the pulse width modulate signal 10 in the fourth time interval still remain on the low-side level standard, the ending point is jumping from low-side level standard to high-side level standard.

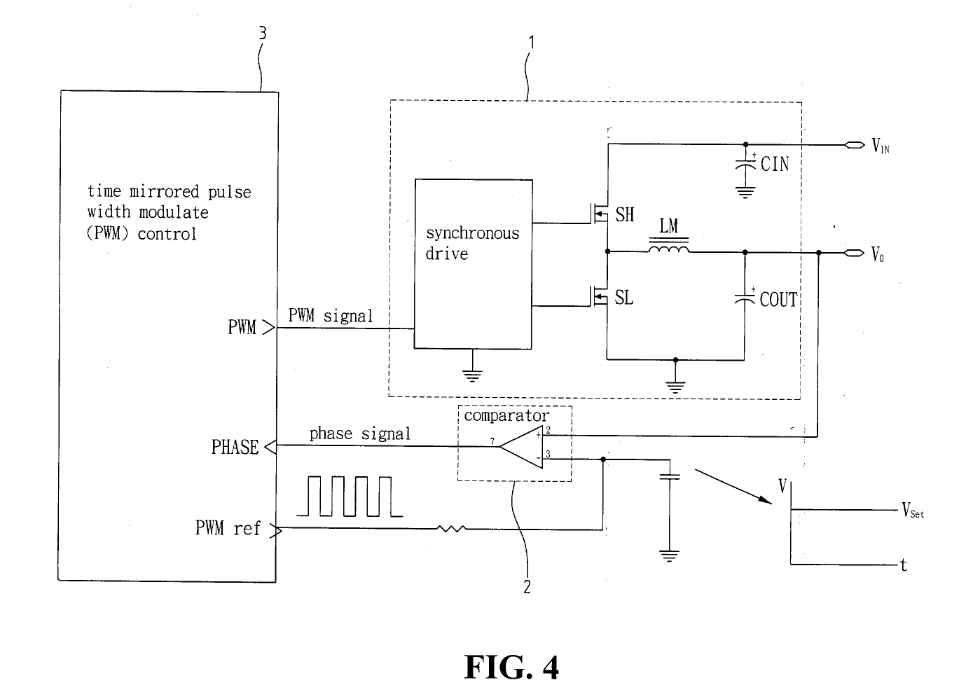

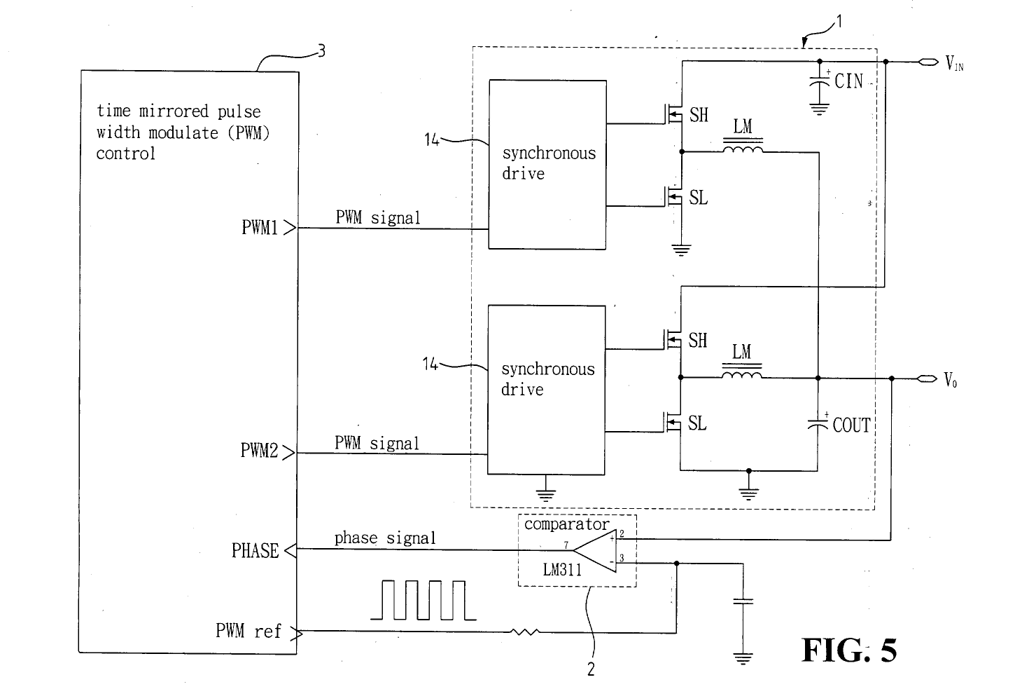

FIG. 4 is a detailed circuit connection diagram of the first embodiment of the present invention, while FIG. 5 is a detailed circuit connection diagram of the third embodiment of the present invention. The distinct difference is that each synchronous drive can only output 10 Ampers in maximum capacity. If there is a necessary for the converter to output 20 Ampers, it must connect two synchronous converters in parallel.

In the third embodiment of the present invention, it is also a method using the phase signal time domain mirrored way to obtain a characteristic such that the time of high level standard and the elapsed time of low level standard is equal, and such that the root mean square of the converter unit 1 output voltage 12 (Vo) equal to a preset voltage (Vo) 20.

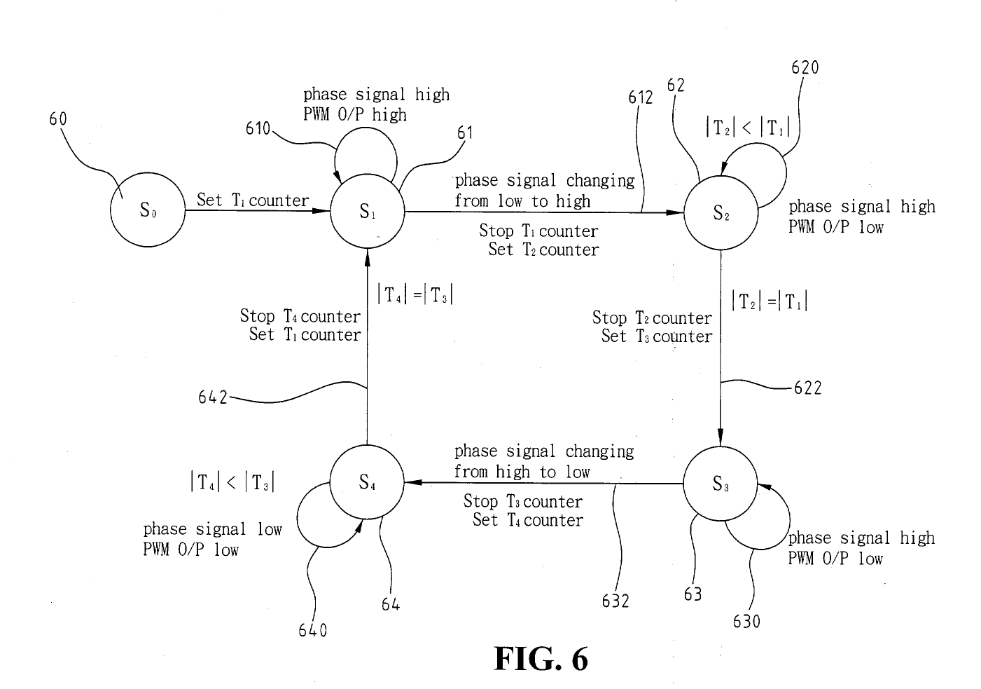

FIG. 6 is the state transition diagram of digital time mirrored pulse width modulate.

The zero state (So) 60 representing system reset, normally, a preset voltage is fixed to let the associated device function well. When the first time interval time counter is set, the first state (S1) begins.

In the first state (S1) 61, the phase signal is kept in low phase, the output is the pulse width modulate high-side signal 610.

When the phase signal is jumping from low phase to high phase 612, stop the time counter of the first time interval (T1), and set the time counter of the second time interval, when entering the second state (S2). In the second state (S2) 62, the phase signal is kept in high phase, the output pulse width modulate is high-side signal 620.

When the elapsed time of second time interval (T2) is equal to the elapsed time of first time interval (T1) 622, stop the time counter of the second time interval, set the time counter of the third time interval, then entering the third state (S3).

In third state (S3), the phase signal is high phase, the output is pulse width modulate low-side signal 630. When phase signal is changing from high phase to low phase 632, stop the time counter of the third time interval (T3) and set time counter of the fourth time (T4), then entering the fourth state (S4)64. In the fourth state (S4) 64, the phase signal is kept in low phase, the output is pulse width modulate low-side signal 640.

When the elapsed time of the fourth time interval is equal to the elapsed time of third time interval 642 (T3), stop the time counter of the fourth time interval and set the time counter of the first time counter, then entering state 1 (S1) 61 again.

As will be understood by persons skilled in the art, the foregoing preferred embodiment of the present invention is illustrative of the present invention than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of of which should be accorded the broadest interpretation so as to encompass all such modification and similar structure.

What is claimed is:

1. A digital time mirrored pulse width modulate controller is electrically connected to a converter unit, said converter comprises at least one input terminal and at least one output terminal, said input terminal is the input channel of pulse width modulate signal, through the control of said input pulse width modulate signal, said output terminal generates an output voltage (Vo), for providing for the use of at least one load, wherein said controller comprises:
at least one comparator unit, said comparator unit having a positive input terminal, a negative input terminal and an output terminal, wherein said positive input terminal and said negative input terminal having an output voltage (Vo) and a set voltage (Vset) from said converter unit, said output terminal providing a phase signal for output, said phase signal having a high-level standard and a low-level standard;
a core digital processing, said core processing unit having at least one input terminal and at least one output terminal, said input terminal receive said phase signal as an input and output a pulse width modulate to an output terminal; and
through the units above, the elapsed time of said phase signal in said high-level and the elapsed time of the phase signal in said low-level are equal, and the root mean square of said output voltage in said converter unit is equal to said preset voltage.

2. The digital time mirrored pulse width modulate controller as claimed in claim 1, wherein said set voltage (Vset) value lies between the peak and trough level (not included) in said converter output voltage.

3. The digital time mirrored pulse width modulate controller as claimed in claim 1, wherein said pulse width modulate signal having a high-side level standard and low-side level standard, wherein said high-side level standard pulse width modulate signal is able to drive load, while said low-side level standard pulse width modulate signal is unable to drive load in said converter unit.

4. The digital time mirrored pulse width modulate controller as claimed in claim 3, wherein said pulse width modulate signal in a time period, having a continuous high-side level standard and a continuous low-side level stand,.

5. The digital time mirrored pulse width modulate controller as claimed in claim 4, wherein said pulse width modulate signal at the initial stage is started by a default to make the pulse width modulate jumping from low-side level standard to high-side level standard.

6. The digital time mirrored pulse width modulate controller as claimed in claim 5, wherein said the pulse width modulate signal in a period time interval contains a first time interval, a second time interval, a third time interval, and a fourth time interval, wherein the elapsed time of said first time interval and said second time interval is equal, wherein the elapsed time of said third time interval and said fourth time interval is equal, in another word, the sum of the elapsed time of said first time interval and said fourth time interval is equal to the sum of the elapsed time of said second time interval and said third time interval.

7. The digital time mirrored pulse width modulate controller as claimed in claim 6, wherein said ending point of said first time interval is the time when phase signal jumping from low-level to high-level, said pulse width modulate signal in the first time interval remains on high-side level standard.

8. The digital time mirrored pulse width modulate controller as claimed in claim 7, wherein said starting point of second time interval is the ending point of said pulse width modulate signal in said first time interval, wherein said ending point of second time interval is calculated from the stating point of said second time interval through first time interval, and the pulse width modulate signal in the second time interval remain on high-side level standard, the ending point of the second time interval is the time when dropping from said high-side to said low-side level standard.

9. The digital time mirrored pulse width modulate controller as claimed in claim 8, wherein said starting point of said third time interval is the ending point in second time interval of said pulse width modulate signal, said ending point of said third time interval dropping from said high-level standard to said low level standard, and said pulse width modulate signal in third time interval remain on low-side level standard.

10. The digital time mirrored pulse width modulate controller as claimed in claim 9, wherein said starting point of the fourth time interval is the ending point of said third time interval of said pulse width modulate signal, said ending point of said fourth time interval is calculated from the starting point of said fourth time interval, in principle, it is the starting point of next period, and said pulse width modulate signal in the fourth time interval remain on low-side level standard, the ending point of said fourth time interval is jumping from low-side level standard to high-side level standard.
